(19) United States
(12) Patent Application Publication
(10) Pub. No.: US 2015/0084258 A1
(43) Pub. Date: Mar. 26, 2015

(54) TOOL ASSEMBLY

(71) Applicant: GM GLOBAL TECHNOLOGY OPERATIONS LLC, Detroit, MI (US)

(72) Inventor: Kenneth J. Gosinski, Macomb, MI (US)

(73) Assignee: GM GLOBAL TECHNOLOGY OPERATIONS LLC, Detroit, MI (US)

(21) Appl. No.: 14/032,492

(22) Filed: Sep. 20, 2013

(51) Int. Cl. B25B 5/16; B25B 5/04

(52) U.S. Cl. CPC B25B 5/16; B25B 5/04
USPC 269/238; 269/286

(57) ABSTRACT

The tool assembly can be used in a manufacturing process and includes a support structure and a clamp arm pivotally coupled to the support structure. The tool assembly further includes a base fixed to the support structure. The clamp arm is configured to move relative to the base between an open position and a closed position. The clamp arm is wholly or partly made of a polymeric material, the polymeric material include at least one polyamide. The tool assembly can hold a panel between the base and the clamp arm when the clamp arm is in the closed position.

### TECHNICAL FIELD

The present disclosure relates to a tool assembly.

### BACKGROUND

Tool assemblies are typically used in a manufacturing process. For example, tool assemblies are used to manufacture a vehicle. Tool assemblies may be used for different purposes. For instance, a tool assembly can be used to hold several panels in a fixed relative position while a welding instrument welds the panels together.

### SUMMARY

The present disclosure relates to a tool assembly such as a clamping assembly. It is useful to develop a tool assembly at least partially made of a polymeric material in order minimize its weight. By minimizing the weight, the tool assembly may be lifted without the aid of a machine. In addition, manufacturing the tool assembly with a polymeric material minimizes machining and maintenance costs.

In an embodiment, the tool assembly can be used in a manufacturing process and includes a support structure and a clamp arm pivotally coupled to the support structure. The support structure may be a substantially planar support structure such as a blade. The tool assembly further includes a base fixed to the support structure. The clamp arm is configured to move relative to the base between an open position and a closed position. The clamp arm is wholly or partly made of a polymeric material. The polymeric material includes at least one polyamide. The tool assembly can hold a panel between the base and the clamp arm when the clamp arm is in the closed position.

In another embodiment, the tool assembly includes a riser made of a metallic material and a support structure coupled to the riser and made of a polymeric material. As used herein, the term “riser” refers to a device capable of supporting and elevating an object from a platform. The tool assembly further includes a base fixed to the support structure and a clamp arm pivotally coupled to the support structure. The clamp arm is made of the polymeric material and is configured to move relative to the support structure between an open position and a closed position. The polymeric material includes polycaprolactam. The tool assembly is configured to hold a panel between the base and the clamp arm when the clamp arm is in the closed position.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic perspective view of a tooling assembly in accordance with an embodiment of the present disclosure;

FIG. 2 is a schematic front view of the tooling assembly shown in FIG. 1;

FIG. 3 is a schematic side view of the tooling assembly shown in FIG. 1; and

FIG. 4 is an enlarged schematic cross-sectional view of a portion of the tooling assembly, taken along section line 4-4 of FIG. 3.

### DETAILED DESCRIPTION

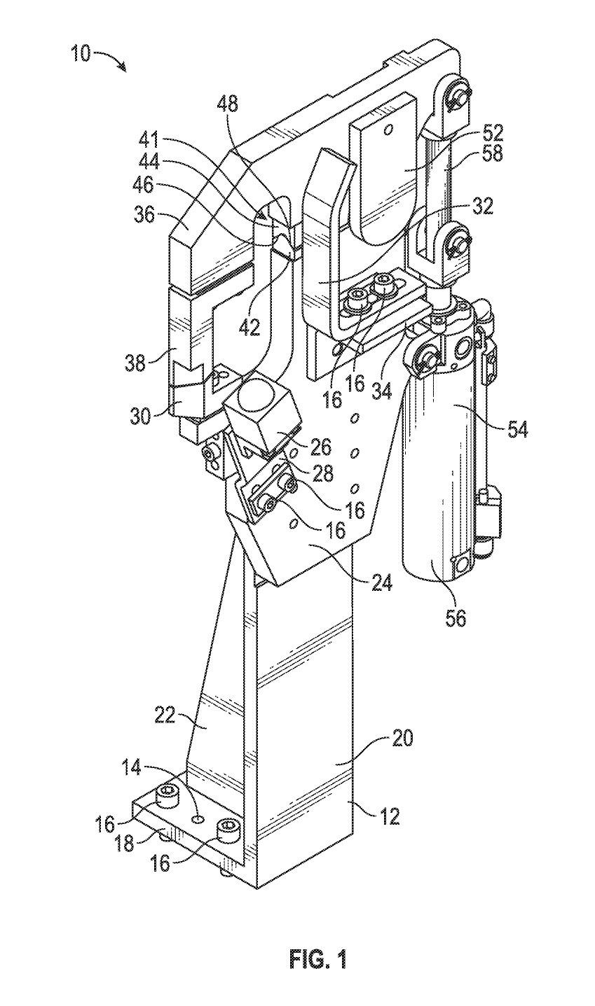

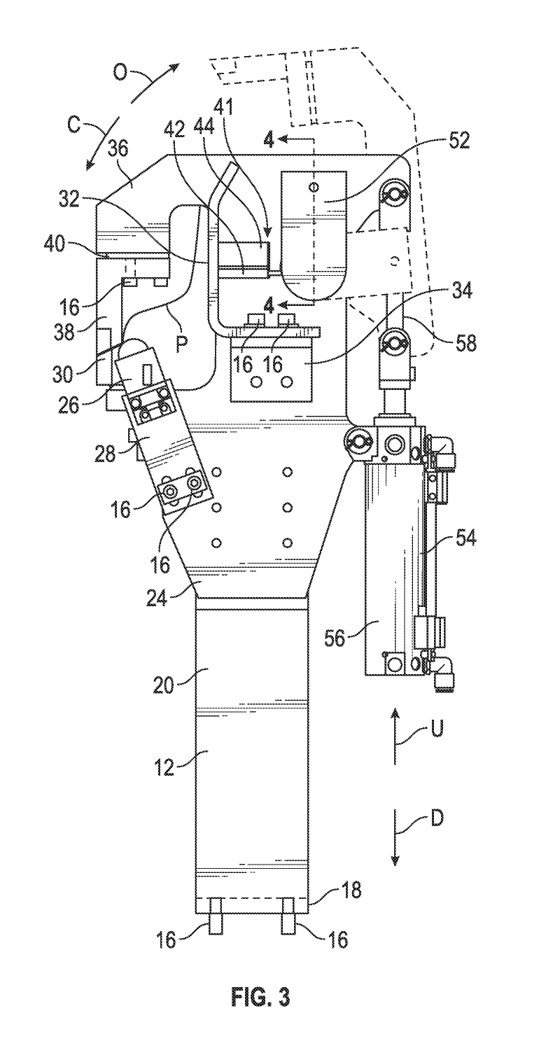

Referring to the drawings, wherein like reference numbers refer to like components, FIGS. 1-3 include schematically illustrate a tool assembly 10 configured for use in a manufacturing process. For example, the tool assembly 10 can be used to manufacture components of a vehicle such as a car or a truck. Specifically, the tool assembly 10 can be used to hold at least one panel P (FIG. 3). The panel P can be held to allow another instrument to perform work on the panel P. For instance, the panel P can be held by the tool assembly 10 while a welding instrument welds the panel to another panel or object. Specifically, the panel P can be clamped by the tool assembly 10. The tool assembly 10 may therefore be referred to as a clamping assembly.

The tool assembly 10 includes a riser 12 configured to be placed on a platform such as a floor or a table. As used herein, the term “riser” refers to a device capable of supporting and elevating an object from a platform. In the depicted embodiment, the riser 12 can be attached to a platform (not shown) such as a table or floor. To do so, the riser 12 may define one or more riser holes 14 configured, shaped, and sized to receive a fastener 16 such as a bolt. The fasteners 16 can couple the riser 12 to the platform.

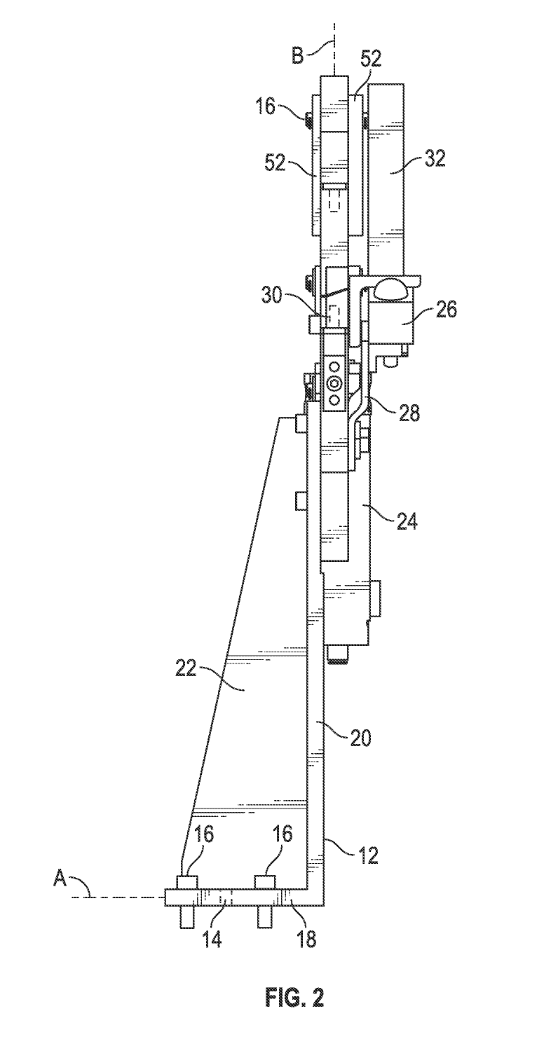

The riser 12 includes a first riser section 18 that defines the riser holes 14. The first riser section 18 is elongated along a first axis A (FIG. 2) and can be directly coupled to a platform. The riser 12 further includes a second riser section 20 coupled to the first riser section 19. The second riser section 20 is substantially perpendicular to the first riser section 18. Specifically, the second riser section 20 is elongated along a second axis B (FIG. 2). The second axis B is substantially perpendicular to the firs axis A. The riser 12 may further include a rib 22 for providing structural support to the first and second riser sections 18, 20. The rib 22 is coupled between the first riser section 18 and second riser section 20. The first riser section 18, second riser section 20, and rib 22 collectively form the riser 12. The riser 12 may alternatively be referred to as a bracket. The riser 12 may be wholly or partially made of a metallic material such as aluminum. It is nevertheless envisioned that the riser 12 may be wholly or partly made of a polymer material.

In addition to the riser 12, the tool assembly 10 includes a support structure 24 coupled to the riser 12. The support structure may be a substantially planar support structure such as a blade. Accordingly, the support structure 24 may be referred to as a blade. The riser 12 is therefore configured to elevate the support structure 24 from a platform such as a table or floor. The riser 12 is therefore coupled to the support structure 24. The support structure 24 may alternatively be referred to as a support member and may be wholly or partly made of a polymeric material. This polymeric material may include one or more polyamides, which are commonly known as nylon polymers. Thus, the support structure 24 can be wholly or partly made of at least one polyamide. As non-limiting examples, the support structure 24 may be wholly or partly made of polycaprolactam (commonly known as Nylon 6), a copolymer of a diamine monomer having 6 carbon atoms and a dibasic acid monomer having a 12 carbon atoms (commonly known as Nylon 6, 12), or a combination thereof. The polymeric material of the support structure 24 (or any other component of the tool assembly 10) may have tensile strength ranging between about 12,000 and about 13,500 pounds per square inch (psi). The sheer strength of the polymeric material may range between about 10,000 and about 11,000 psi. The polymeric material may have a compressive strength ranging between 15,000 and 18,000 psi. The Rockwell Hardness of the polymeric material may range between about 115 and about 125 R. Further, the polymeric material may have a Shore Hardness ranging between about 78 and 83 D. The melting point of the polymeric material may range between about 410 and about 460 degrees Fahrenheit. The polymeric material may have a specific gravity of about 1.15. As used herein, the term “specific gravity” means the ratio of the density of the polymeric material compared to the density of water. It is useful to make the support structure 24 (or any other component of the tool assembly 10) of the polymer material with the properties listed above in order to allow the tool assembly 10 to be properly used as a manufacturing tool while, at the same time, minimizing weight and machining and maintenance costs. Therefore, it is useful to make the support structure 24 (or any other component of the tool assembly 10) of a polymeric material having the properties listed above. It is contemplated that the riser 12 may be wholly or partly made of the polymer material with properties listed above in order to minimize weight and costs. It also useful to make the support structure 24 and riser 12 of the polymeric material described above because the different components of the tool assembly 10 can be made in different colors, thereby aiding a user to identify the different parts of the tool assembly 10.

The tool assembly 10 further includes a proximity sensor 26 mechanically coupled to the support structure 24. The term “proximity sensor” refers to a sensor able to detect the presence of nearby objects without any physical contact. The proximity sensor 26 can be used to detect the presence of the panel P (FIG. 3) near the tool assembly 10. Moreover, the proximity sensor 26 can generate a signal to a controller (not shown) to inform the controller that the panel P is near the tool assembly 12. The tool assembly 10 may include a coupler 28, such as a bracket, interconnecting the proximity sensor 26 to the support structure 24. The tool assembly 10 may include fasteners 16, such as bolts, coupling the support structure 24 to the coupler 28.

The tool assembly 10 further includes a base 30 coupled to the support structure 24. Specifically, the base 30 is fixed to the support structure 24. Thus, the base 30 does not move relative to the support structure 24. The base 30 may be wholly or partly made of the polymeric material described above. It is therefore envisioned that the base 30 may be wholly or partly made of the same polymeric material as the support structure 24. The base 30 can receive at least a portion of the panel P as discussed above. Specifically, a portion of the panel P can rest on the base 30.

The tool assembly 10 further includes a locator 32 operatively coupled to the support structure 24 and may be wholly or partly made of a metallic material such as steel or aluminum. As used herein, the term “locator” means a device capable of positioning the panel P at a specific location relative to the base 30. The locator 32 may be configured as a plate. An angle bracket 34 may couple the locator 32 to the support structure 24. As used herein, the term “angle bracket” means a bracket that has at least two sections angled relative to each other. A plurality of fasteners 16 may couple the angle bracket 34 to the support structure 24 and the locator 32.

In addition to the locator 32, the tool assembly 10 includes a clamp arm 36 wholly or partly made of a polymeric material and movably coupled to the support structure 24. The clamp arm 36 may be wholly or partly made of the same polymeric material as the support structure 24. As discussed in detail below, the clamp arm 36 may be pivotally coupled to the support structure 24.

The tool assembly 10 further includes a pressure foot 38 coupled to the clamp arm 36. As used herein, the term “pressure foot” means a device capable of applying pressure to the panel P when the panel P is disposed on the base 30. At least one fastener 16 may couple the clamp arm 36 to the pressure foot 38. A spacer 40 (FIG. 3) may be disposed between the pressure foot 38 n and the clamp arm 36 in order to distribute the load of the fasteners 16 connecting the pressure foot 16 to the clamp arm 36. Because the pressure foot 38 is fixed to the clamp arm 36, the pressure foot 38 can move in unison with the clamp arm 36. When the clamp arm 36 is in the closed position, the pressure foot 38 can contact and exert pressure on the base 30.

The clamp arm 36 may be pivotally coupled to the support structure 24. As such, the clamp arm 36 can move relative to the support structure 24 and base 30 between a first or open position (shown in broken lines in FIG. 3) and a second or closed position (shown in solid lines in FIG. 3). In the first position, the pressure foot 38 is spaced apart from the base 30, thereby allowing a user to position the panel P between the pressure foot 38 and the base 30. In the second position, the pressure foot 38 is approximated to the base 30 and, therefore, the panel P is clamped between the pressure foot 38 and the base 30. Because the clamp arm 36 may be pivotally coupled to the support structure 24, the clamp arm 36 can pivot relative to the support structure 24 and base 30 between the first and second positions.

The tool assembly 10 can be used to clamp the panel P in order to perform work on the panel P. For example, the tool assembly 10 can hold the panel P at a fixed position between the clamp arm 36 and base 30 while a welding instrument welds the panel P to another object. To do so, the panel P may be disposed between the clamp arm 36 and base 30 while the clamp arm 36 is in the first or open position. Then, the clamp arm 36 can be moved relative to the base 30 toward the closed position, thereby clamping the panel P between the clamp arm 36 and base 30. Accordingly, the tool assembly 10 is configured to hold the panel P between the clamp arm 36 and base 30 when the clamp arm 36 is in the closed position.

The tool assembly 10 may further include a locating block set 41 coupled between the support structure 24 and the clamp arm 36. As used herein, the term “locating block set” means a plurality of blocks that facilitates positioning two or more object at a specific location relative to each other. In the depicted embodiment, the locating block set 41 facilitates positioning the clamp arm 36 at a specific location relative to the support structure 24 when the clamp arm 36 is in the second position. The locating block set 41 includes a first block 44 attached to the support structure 24 and a second block 42 attached to the clamp arm 36. The first and second blocks 44, 42 may have first and complementary surfaces 46, 48, respectively. The first and second complementary surfaces 46, 48 are complementary to each other, thereby allowing the first and second blocks 44, 42 to fix the position of the clamp arm 36 relative to the support structure 24 when the clamp arm 36 is in the second position. For example, the second complementary surface 48 may define a substantially v-shaped notch configured to receive an inverted v-shaped protrusion defined by the first complementary surface 46. The v-shaped notch defined by the second complementary surface 48 is configured and sized to be received in the v-shaped notch defined by the second complementary surface 48.

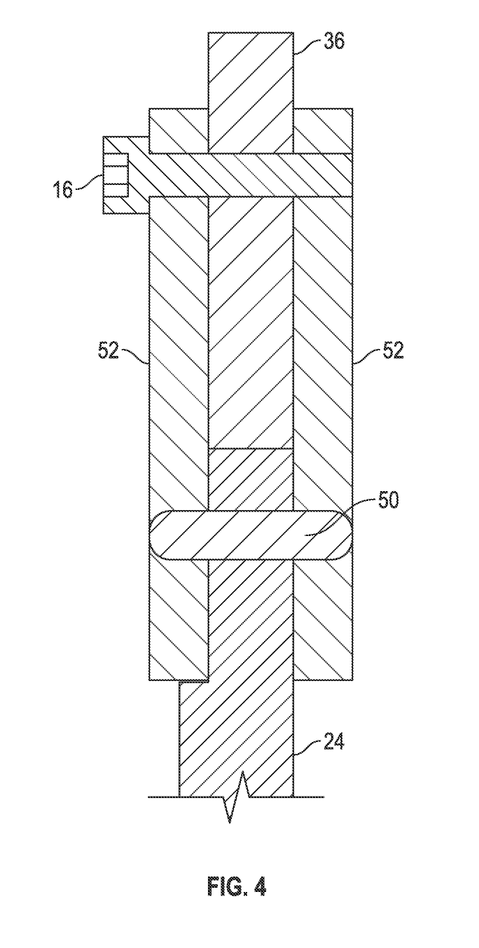

With reference to FIG. 4, the tool assembly 10 may include a pivot pin 50 pivotally coupling the clamp arm 36 to the support structure 24. The pivot pin 50 is coupled to two plates 52 disposed on opposite sides of the support structure 24. Each plate 52 extends from the support structure 24 to the clamp arm 36. A fastener 16, such as a screw or a bolt, can couple the plates 52 to the clamp arm 36. Each plate 52 may be wholly or partly made of a polymeric material. For instance, each plate 52 may be at least partially made of the same polymeric material as the support structure 24. Although FIG. 4 shows two plates 52, it is contemplated that the tool assembly 10 may have more or fewer plates 52. Accordingly, the pivot pin 50 may be coupled to at least one plate 52. Hence, at least one plate 52 is coupled to the pivot pin 50 and clamp arm 36.

With reference again to FIGS. 1-3, the tool assembly 10 further includes an actuator 54 configured to move the clamp arm 36 between the first and second positions. The actuator 54 is coupled to the clamp arm 36 and can be actuated to move the clamp arm 36 between the first and second positions. The actuator 54 may be a hydraulic cylinder. As used herein, the term “hydraulic cylinder” refers to a mechanical actuator that is used to give a unidirectional force through a unidirectional stroke. In the depicted embodiment, the actuator 54 includes a barrel 56 and a rod 58 movably coupled to the barrel 56. The actuator 54 can be actuated to move the rod 58 along a single direction relative to the barrel 56. Because the rod 58 is coupled to the clamp arm 36, the movement of the rod 58 relative to the barrel 56 causes the clamp arm 36 to move relative to the support structure 24 and the base 30 between the first and second positions. The rod 58 can move relative to the barrel 56 in a first or downward direction indicated by arrow D or a second or upward direction indicated by arrow U. The first direction D is opposite to the second direction U. The actuator 54 can be actuated to move the rod 58 relative to the barrel 56 in the first or downward direction indicated by arrow D. The downward movement of the rod 58 relative to the barrel 56 causes the clamp arm 36 to move toward the open position in the direction indicated by arrow O. Conversely, moving the rod 58 in the second direction U causes the clamp arm 36 to move toward the closed position in the direction indicated by arrow C.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A tool assembly, comprising:
a support structure;
a clamp arm pivotally coupled to the support structure;
a base fixed to the support structure, wherein the clamp arm is configured to move relative to the base between an open position and a closed position;
wherein the clamp arm comprises a polymeric material including at least one polyamide; and
wherein the tool assembly is configured to hold a panel between the base and the clamp arm when the clamp arm is in the closed position.

2. The tool assembly of claim 1, wherein the support structure comprises the polymeric material.

3. The tool assembly of claim 2, further comprising a riser coupled to the support structure.

4. The tool assembly of claim 3, wherein the riser comprises a metallic material.

5. The tool assembly of claim 1, further comprising a pressure foot coupled to the clamp arm, the pressure foot being configured to contact the base when the clamp arm is in the closed position.

6. The tool assembly of claim 1, further comprising a pivot pin coupled to the support structure and a plate coupled to the pivot pin, wherein the plate is coupled to the clamp arm.

7. The tool assembly of claim 1, wherein the plate comprises the polymeric material.

8. The tool assembly of claim 1, wherein the polymeric material comprises polycaprolactam.

9. The tool assembly of claim 1, wherein the polymeric material comprises a copolymer of a diamine monomer having 6 carbon atoms and a dibasic acid monomer having 12 carbon atoms.

10. The tool assembly of claim 1, wherein the polymeric material has a tensile strength between 12,000 and 13,500 pounds per square inch.

11. The tool assembly of claim 1, wherein the polymeric material has a compressive strength ranging between 15,000 and 18,000 pounds per square inch.

12. The tool assembly of claim 1, wherein the polymeric material has a Rockwell hardness ranging between 115 and 125 R.

13. The tool assembly of claim 1, wherein the polymeric material has a Shore hardness ranging between 78 and 83 D.

14. The tool assembly of claim 1, wherein the polymeric material has a melting point ranging between 410 and 460 degrees Fahrenheit.

15. The tool assembly of claim 1, wherein the polymeric material has a specific gravity of about 1.15.

16. A tool assembly, comprising:
a riser made of a metallic material;
a support structure coupled to the riser and made of a polymeric material;
a base fixed to the support structure;
a clamp arm pivotally coupled to the support structure, the clamp arm made of the polymeric material, the clamp arm being configured to move relative to the support structure between an open position and a closed position;
wherein the polymeric material includes polycaprolactam; and
wherein the tool assembly is configured to hold a panel between the base and the clamp arm when the clamp arm is in the closed position.

17. The tool assembly of claim 16, wherein the polymeric material has a tensile strength between 12,000 and 13,500 pounds per square inch.

18. The tool assembly of claim 16, wherein the polymeric material has a compressive strength ranging between 15,000 and 18,000 pounds per square inch.

19. The tool assembly of claim 16, wherein the polymeric material has a specific gravity of about 1.15.

20. The tool assembly of claim 16, further comprising an actuator coupled to the clamp arm, the actuator being configured to move the clamp arm between the open and closed positions.
